(19) United States
(12) Patent Application Publication
(10) Pub. No.: US 2017/0055655 A1
(43) Pub. Date: Mar. 2, 2017

(54) SYSTEM AND METHOD FOR MANAGING FUNDS WITH A TOY

(71) Applicants: Mark Meyers, Thousand Oaks, CA (US); Jorge Freitas, Maple Ridge (CA); Salvatore DiVita, Carlsbad, CA (US)

(72) Inventors: Mark Meyers, Thousand Oaks, CA (US); Jorge Freitas, Maple Ridge (CA); Salvatore DiVita, Carlsbad, CA (US)

(21) Appl. No.: 15/247,613

(22) Filed: Aug. 25, 2016

Related U.S. Application Data
(60) Provisional application No. 62/324,890, filed on Apr. 20, 2016.
(60) Provisional application No. 62/209,829, filed on Aug. 25, 2015.

(51) Int. Cl. A45C 1/12; G06Q 20/32; G06Q 20/10

(52) U.S. Cl. CPC A45C 1/12; G06Q 20/108; G06Q 20/327

(57) ABSTRACT

A system for managing a fund account includes providing a device such as a device resembling a traditional piggy bank which receives data signals when transactions are made within the fund account. The device preferably includes a visual indicator such as light-emitting diodes to indicate that such a transaction has been made. The device may also include an audible indicator to indicate that transactions have been made. The device preferably also displays savings goals and the status of the fund account in reaching that goal. A communication device such as a cellular phone may communicate with the device and send it such data signals, as well as communicate with a server to receive data signals when there is activity within the fund account.

### CROSS REFERENCE TO RELATED APPLICATIONS

The application claims the benefit of U.S. Provisional Application No. 62/209,829, filed on Aug. 25, 2015 and U.S. Provisional Application No. 62/324,890 filed on Apr. 20, 2016, which are incorporated by reference herein in its entirety.

### FIELD OF INVENTION

The invention is related to a fund managing system having a device which provides notification of activity within the fund account, such as when a deposit is made.

### BACKGROUND OF THE INVENTION

The invention relates generally to a system for managing fund accounts, more particularly, for allowing third parties to deposit funds into the account and notifying the account holder when such deposits are made via a physical device, such as a toy.

Many banks expend large sums in advertizing and campaigns to get customers of around ages 5-16. Current value of the untapped market is about $100-200/yr/child with potential to turn them into long-term loyal customers. Many children may have piggy banks at home into which they insert cash to save money, but most of them would likely not go to the bank to make such deposits. This may partly be because putting money into a piggy bank gives them instant gratification, including both a visual indication that money has been inserted, and a physical item which represents the money that they have accumulated. When coins are inserted into piggy banks, the clinking sound of the coin hitting the other coins in the piggy bank may also provide gratification for the child. In contrast, depositing money into a bank account results in their money being taken physically from them, and the concept of their money being in an invisible account may be too abstract for them to appreciate.

Accordingly, it is desirable to provide an improved system for managing a fund account including a physical device which provides a visual and/or audible notification whenever funds are deposited into the account, which overcomes drawbacks and inadequacies of known methods and systems.

### SUMMARY OF THE INVENTIONS

Generally speaking, in accordance with an embodiment of the invention, a system includes a device preferably having the appearance of a piggy bank or toy in wireless communication with a communication device such as a mobile device. The communication device preferably runs an application for managing a fund account associated with the device, so that whenever a deposit is made into the fund account, the communication device transmits a signal to the device and the device provides a visual and/or audible alert.

An embodiment of the invention provides a method in which funds may be managed and preferably encourage the use of fund accounts by associating transactions within the fund accounts with a physical item such as a piggy bank, toy or other item.

Another embodiment of the invention is directed to a reward system for rewarding the performance of certain tasks, obtaining certain goals, etc.

Yet another embodiment of the invention is directed to a savings system for saving money to achieve certain goals.

Another embodiment of the invention is directed to a piggy bank associated with a fund account, the piggy bank having technology built in to communicate with a mobile device, the piggy bank further having visual and/or audible indicators to indicate activity in the fund account.

Still other objects and advantages of the invention will in part be obvious and will in part be apparent from the specification. Other features and advantages of this invention will become apparent in the following detailed description of exemplary embodiments of this invention with reference to the accompanying drawings.

### BRIEF DESCRIPTION OF THE DRAWINGS

For a fuller understanding of the invention, reference is made to the following description taken in connection with the accompanying drawing, in which:

FIG. 1 is a diagram illustrating a system in accordance with an embodiment of the invention;

FIG. 2 is an illustration of a device in accordance with an embodiment of the invention; and

FIG. 3 is an illustration of a device in accordance with an embodiment of the invention.

### DETAILED DESCRIPTION OF THE PREFERRED EMBODIMENTS

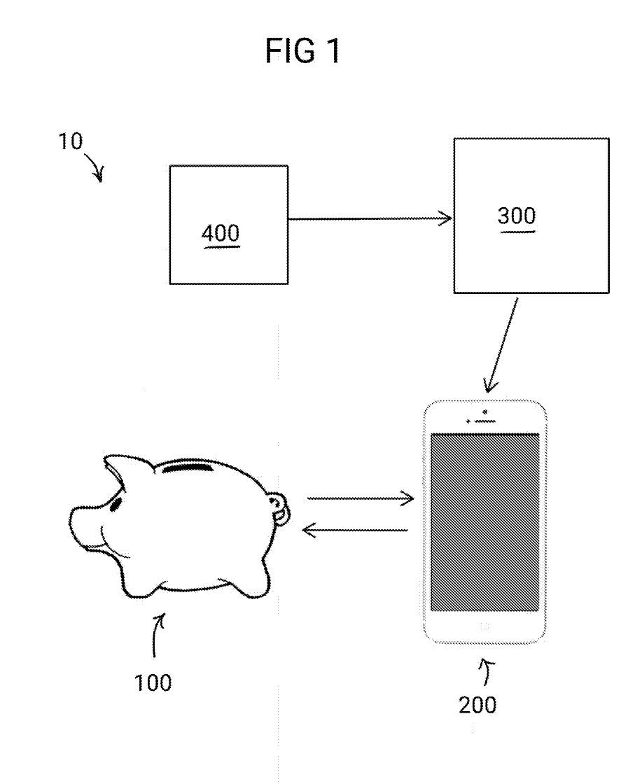

The invention generally is directed to a fund managing system 10, a method for managing funds and a device for use with a fund managing system, wherein system 10 generally includes a physical device 100, a communication device 200 and a server 300 as illustrated in FIG. 1. Device 100 preferably provides visual and/or audible notifications of deposits made into the associated fund account, which may be a bank account, an online fund account such as PayPal®, a Bitcoins account, iTunes®, Google Play® or any other fund account.

Preferably, device 100 has the physical appearance of a piggy bank, toy or another appearance that may appeal to the account holder. For example, the shape of an animal such as a pig, rabbit, lion, dog, etc. may be preferred for a young child. For older account holders, it make be preferred to include other shapes or designs, by way of non-limiting example, a sports team logo, a basketball, baseball, a car, a plane, a boat, a robot, a doll, a musical instrument, etc. By providing a toy-like device that provides visual and/or audible notifications, device 100 may appear more like an actual toy and appeal to a child, which may make the child want to make more deposits or have more deposits made into their fund account in order to see/hear the notification, thus encouraging them to save. System 10 may provide a similar gratification as a physical piggy bank into which the child would insert cash, thus encouraging them to create and/or utilize their fund account.

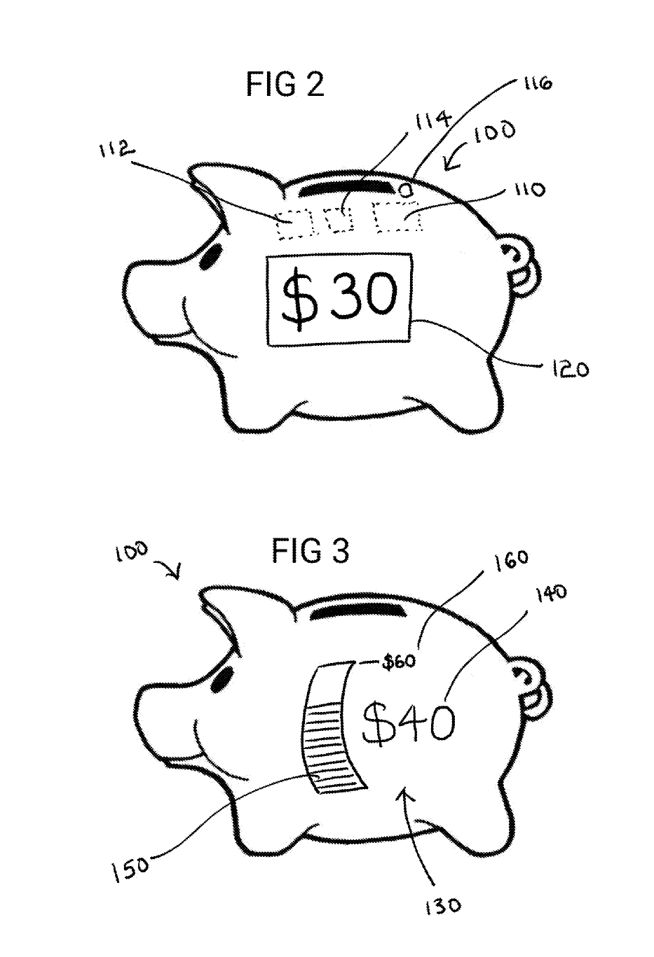

In accordance with an embodiment of the invention illustrated in FIG. 2, device 100 includes a receiver 110, preferably a Bluetooth receiver, for receiving data signals from communication device 200. Device 100 may also include a transmitter or transceiver for sending data signals to communication device 200. Device 100 may also include a processor 112 for processing the data received.

Preferably, device 100 provides a visual notification when funds have been transferred into the fund account, for example, via a visual indicator 116. Examples of visual indicators include one or more LEDs (light-emitting diode) that light up. Each LED may comprise one color or a variety of colors. Alternatively, visual indicator 116 may include moving parts that move, for example, spin, slide, etc. By way of non-limiting example, a helicopter-shaped device may have propellers that spin when a deposit is made, or an animal-shaped device may have a tail that wags when a deposit is made. Furthermore, device 100 may itself rumble, shake, move in a direction, rock side to side, rotate or make other movements. Other visual indicators may be utilized without deviating from the scope of the invention. Preferably, visual indicator 116 may provide more than one visual indication, by way of non-limiting example, various colors of light, blinking versus steady light, varying movements or a combination thereof to differentiate activities or status of the fund account, status of goals achieved, or other reasons for notifications.

Device 100 may provide an audible notification when funds have been transferred into the fund account. Preferably, device 100 includes a speaker 114 which gives off a sound. The type of sound is not limited and may include, but is not limited to, a chirp, a beep, a tune and a audio recording. Preferably, different sounds are emitted to notify of different activities or status of the fund account, for example, a gift, a payment, a status achieved, a goal reached, etc. For a device 100 in the shape or containing an image of an animal, the notification sound may preferably include the animal's sound, for example, a pig's oink, a cow's moo, a dog's bark, etc. For a device 100 in the shape or containing an image of a sport or a sports team, the notification sound may preferably include sounds associated with the sport or sports team. Other combinations of device 100 and notification sound may be provided without deviating from the scope of the invention.

In the embodiment shown, a giver may use communication device 200 or second communication device 400 to launch the application via which the giver transfers funds into the account holder's fund account. Certain examples will be described hereunder for illustrative purposes only. A parent opens a bank account for their child and links it to device 100 and the application. The parent may use their cellular phone as communication device 200 to transfer money into the child's bank account using the application on their phone. Once the transfer is made via the application, the server is notified of the transfer, and the fund-transfer between the parent's payment account and the child's bank account is executed. The server 300 sends a signal to the parent's phone to notify the device 100 of the transfer. The phone, via BTLE, transmits a data signal to the device 100 and in response, an LED on device 100 lights up and device 100 emits a sound, indicating that a deposit has been made. The child sees the LED light up and hears the notification and knows a deposit has been made. The child may check who made the deposit and/or the amount on the device 100, on the parent's phone, on their own communication device running the application, on a computer or other suitable device.

In the embodiment illustrated in FIG. 2, device 100 further includes a display 120. Display 120 may show the balance of the fund account, the amount of the deposit received, the name or image of the giver, or other image or information. For example, display 120 may show a photo of the grandparent who deposited money into a child's bank account as a gift. Display 120 may also show a message from the grandparent. Preferably, the content displayed on display 120 will remain displayed constantly or periodically until it is turned off, either via the application on communication device 200 or by interacting with device 100, for example, by tapping device 100. Alternatively, an LED may blink to indicate activity in the fund account with display 120 remaining off until it is turned on to display the content via the application on communication device 200 or by interacting with device 100, for example, by tapping device 100. The above are merely examples, and alternate options for how display 120 shows or ceases to show content are contemplated without deviating from the scope of the invention.

Display 120 may be a visible screen as shown in FIG. 2, comprise components on the inside of device 100 or be integrated with device 100 such that only the content being displayed is visible as illustrated in FIG. 3. For example, display 130 may comprise a plurality of LEDs on the interior of device 100 such that when certain pattern of LEDs are lit, numbers, status bars, etc. may be visible from the outside. Alternatively, at least a portion of the device itself may be capable of displaying content. For example, the side of device 100 may in itself be capable of displaying text. Illustrated in FIG. 3 is an embodiment in which display 130 shows a variety of information, such as the current balance 140 in the fund account, a status bar 150 and a goal 160. For example, if the account holder is saving up to purchase a certain product, they may set the goal amount and have display 130 show status bar 150 so that they may see how far they have to go before reaching the goal. Whereas only one goal amount is illustrated, display 130 may display more than one goal amount. Such display 130 may show this information constantly, periodically or briefly whenever there is an activity in the fund account, as an application-specific design choice.

Communication device 200 may be a cellular phone, tablet, computer, etc. suitable for communicating with device 100, preferably wirelessly such as via Bluetooth, BTLE (Bluetooth Low Energy), NFC (Near-field communication), WiFi, infrared data transfer, more preferably via BTLE. Communication device 200 preferably runs an application or software (referred to generally herein as “application”) for communicating with device 100 as well as server 300, which may also communicate with a second communication device 400.

Second communication device 400 may be a cellular phone, tablet, computer or other device capable of running the application or software for communicating to server 300. Preferably, a person may use the application on communication device 200 or second communication device 400 to transfer funds into the account holder's fund account. For example, a relative may transfer funds into a child's bank account.

Preferably, communication device 200 is a mobile device having a processor, a transmitter and/or receiver so that communication device 200 may be in data communication with device 100, more preferably at all times when within range of the transmitter. Alternatively, communication device 200 may communicate with device 100 via WiFi or other communication means, such that even if it is not within range of its transmitter, it may send a signal to device 100 regarding an activity in the fund account or other data transmissions.

Server 300 preferably further communicates with the fund account management system, such as a bank, PayPal®, iTunes®, etc. (referred to herein generally as “bank”). Funds may be transferred from a giver's fund account, by way of non-limiting example, a credit card, bank account or PayPal® account, to the recipient's fund account using a means known in the art, such as PayPal®, an online banking systems, or other suitable fund transfer system.

An exemplary embodiment of the invention is described herein, wherein an administrator, such as a parent, has the ability to set tasks such as chores for the account holder, such as a child, to perform prior to receiving a transfer of funds. The parent may provide a list of household chores for the child to perform. Upon completing each chore, the child may notify the parent. The parent may confirm that the chore was properly completed and transfer an amount into the child's fund account. The amount may be predetermined per chore or determined at a later time, for example, at the time the transfer is made. In accordance with a preferred embodiment, the child also has a communication device 100 such as a cellular phone running the application. The child may see the list of chores and perhaps the payment value associated with each. Upon completing a task, the child may indicate such, by clicking “complete” next to the chore or by other means. The child's phone may communicate with server 300 via the application, and the server 300 may send a notification to the parent's phone that certain chores have been completed. In accordance with an embodiment of the system, the application on the parent's phone provides the parent with an approval function to approve that the chore was properly completed. The parent may then transfer an amount into the child's fund account. If the dollar value for the chore was predetermined, such dollar amount preferably appears on the parent's phone so that the parent may transfer that amount without having to remember what the agreed upon amount was. Such an arrangement may facilitate the payment process and reduce the probability of error. Preferably, when the parent processes the fund transfer from their phone via the application, the server is notified of the transaction and processes the fund transfer with the bank. The server further sends a signal to the child's phone which sends a signal to the device 100 to notify the child that a deposit has been made. Preferably, the child's phone will also receive a notification of the deposit, and permit the child to send a thank you note in response.

The application may list goals the account holder seeks to achieve. For example, it may indicate a dollar amount that the account holder wishes to save. It may be a savings goal or it may be in order purchase something, such as a toy. Preferably, givers such as grandparents, friends, etc. may see these goals for the account holder and make deposits specifying that their deposits should apply only toward that goal. For example, a purchase for the product may automatically be processed from an associated vendor, such as Amazon, Toys 'R Us, Best Buy, etc. once the goal is achieved. Alternatively, an administrator may be notified that a goal has been achieved, upon which the administrator may process the purchase.

Preferably, device 100 is significantly waterproof so that it may be washed and comprises a flexible substance safe for handling by children. In accordance with an embodiment of the invention, device 100 may be personalized, for example, painted, decorated, etc. post-sale. A kit may be provided with device 100 including paint, markers, stickers, etc. which are suitable for use with device 100. Personalizing a device 100 may provide a sense of attachment to the device, which may encourage children to use it more and further encourage children to open fund accounts. Similar to craft parties or parties where children build their own stuffed animals, a parent may throw a bank party where each child decorates their own device 100 such as a piggy bank. At the end of the party, each child would have a personalized piggy bank to take home, to which their parents may associate a fund account. Such systems and kits may facilitate getting children to open and maintain a fund account.

Another method of encouraging children to save and utilize the fund account may include providing status according to the amount saved in the fund account, the number of transactions performed, or other basis preferred. For example, with each level advancement, the account holder may be given certain decorative items such as stickers or accessories for the device 100, or items for the application on their communication device 200 such as skins, avatars, icons, etc.

The funds referred to herein may be currency, such as US dollars, but may also be non-monetary, such as Bitcoins, credit or points for certain programs or markets such as iTunes, Google Play, a particular video game, etc. The fund may alternatively be time granted to watch TV, play video games, etc. The goal may alternatively be a certain event, for which the administrator sets certain tasks to be completed in order for the account holder to attend. For example, the event may be a concert, for which a parent requires the child to perform certain chores, obtain certain grades, etc.

Other alterations may be made without deviating from the scope of the invention. Accordingly, the system and method, the use, steps, order of steps, etc. may be varied as a matter of application specific design choice without deviating from the scope of the invention. It is the intention, therefore, to be limited only as indicated by the scope of the claims appended hereto.

It is also to be understood that the following claims are intended to cover all of the generic and specific features of the invention herein described and all statements of the scope of the invention which, as a matter of language, might be said to fall there between.

We claim:

1. A fund managing system comprising:
a notification device having a receiver, said notification device associated with a fund account; and
a communication device having a transmitter and a receiver, said communication device receiving a first data signal from a server regarding a transaction performed within said fund account and transmitting a second data signal to said notification device regarding said transaction;
wherein said notification device includes an indicator which indicates when a transaction has been made within said fund account.

2. The fund managing system of claim 1, wherein said notification device comprises one or more light emitting diodes.

3. The fund managing system of claim 1, wherein said notification device comprises one or more display screens.

4. The fund managing system of claim 1, wherein said notification device comprises one or more moving parts.

5. The fund managing system of claim 1, wherein said notification device comprises a speaker for audio playback.

6. The fund managing system of claim 1, wherein said notification device resembles a piggy bank.

7. The fund managing system of claim 1, wherein said notification device further comprises a transmitter and sends a third data signal to said communication device.

8. The fund managing system of claim 1, wherein said communication device runs an application for receiving said first data signal from said server and transmitting said second data signal to said notification device.

9. The fund managing system of claim 1, wherein said communication device transmits said second data signal to said notification device wirelessly.

10. The fund managing system of claim 1, wherein said communication device transmits said second data signal to said notification device via Bluetooth low energy.

11. The fund managing system of claim 1, wherein said notification device includes a display indicating a goal and a status of said fund account with respect to said goal.

12. The fund managing system of claim 1, further comprising a remote device which sends a fourth data signal to said server regarding a transaction made with respect to said fund account.

13. The fund managing system of claim 1, wherein said indicator includes a plurality of settings, a first setting indicating a first type of transaction different from a second transaction indicated by a second setting.

14. The fund managing system of claim 1, wherein said communication device runs an application listing tasks for said account holder to perform; wherein after a first task is performed, said first task is tagged as being completed and a corresponding transaction is performed.

15. The fund managing system of claim 1, wherein said fund account is a bank account.

16. The fund managing system of claim 1, wherein said fund account contains non-currency.

17. A device for use with the fund managing system of claim 1, the device comprising:
a body having an appearance of a toy;
a receiver receiving a data signal from a communication device, said data signal containing data regarding a transaction in a fund account;
one or more light-emitting diodes; and
a processor processing said data signal and activating said one or more light-emitting diodes upon receiving said data signal.

18. A method of managing funds, said method comprising:
providing a notification device;
associating said notification device with a fund account, said notification device having an indicator;
receiving on a communication device a first data signal regarding a transaction within said fund account;
transmitting a second data signal regarding said transaction from said communication device to said notification device; and
activating said indicator.

19. The method of claim 18, wherein transmitting said second data signal comprises transferring said data signal via Bluetooth low energy.

20. The method of claim 18, further comprising activating a display and displaying a goal and a status of said fund account with respect to achieving said goal.

21. The method of claim 18, wherein providing said notification device comprises providing a device having an appearance of a piggy bank.
